(19) United States
(12) Patent Application Publication
(10) Pub. No.: US 2008/0125144 A1
(43) Pub. Date: May 29, 2008

(54) Location Determination

(76) Inventors: Ville Ruutu, Espoo (FI); Jarko Niemenmaa, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/563,096

(22) Filed: Nov. 24, 2006

(51) Int. Cl. H04Q 7/00; H04M 1/00

(52) U.S. Cl. 455/457; 455/550.1

(57) ABSTRACT

Apparatus and a software module are shown based on a method comprising determining in which sector of a split cell in a cellular network a mobile device is located by processing communications data associated with communications between the mobile device and a reference cell in the cellular network; and determining a sector boundary of the sector in which the mobile device is located by processing sector-related data associated with the split cell, the sector boundary providing an approximate determination of the geographical location of the mobile device.

### BACKGROUND

The invention relates to a method and apparatus for determining the location of a mobile device, and particularly for determining the location of a mobile device having access to a cellular network.

A known method of determining the location of a mobile device includes using information provided by a cellular network during communications with the mobile device to determine that the mobile device is located within a particular cell of the network. This location information may be used as part of a signal acquisition process when searching for a signal from a satellite of the Global Positioning System (GPS), sometimes referred to as obtaining a fix.

The listing or discussion of a prior-published document in this specification should not necessarily be taken as an acknowledgement that the document is part of the state of the art or is common general knowledge.

### SUMMARY

According to a first aspect of the invention, there is provided a method comprising
determining in which sector of a split cell in a cellular network a mobile device is located by processing communications data associated with communications between the mobile device and a reference cell in the cellular network;
determining a sector boundary of the sector in which the mobile device is located by processing sector-related data associated with the split cell, the sector boundary providing an approximate determination of the geographical location of the mobile device.

The term “mobile device” relates to any electronic device or terminal which is capable of communicating with the cellular network, and may include the functionality of any or all of a radiotelephone, a personal digital assistant, a personal computer, or a portable music/video player, for example.

The term “split cell” relates to a cell in which two or more sectors share a cell identity.

Thus, by utilization of minor data additions, assisted location can be offered.

The method may include using knowledge of the sector boundary in which the mobile device is located to perform further location-determination operations. The further location determination operations may include use of a timing advance value, received signal strengths, cell identity, round trip time (RTT) and/or pathloss measurements, for example.

The sector-related data may include a sector bearing, a sector width and a sector maximum range.

The reference cell may be a neighboring cell adjacent the split cell.

The communications data may include a received signal strength associated with communications between the mobile device and a network element of the reference cell.

Processing the communications data may include comparing the received signal strength to a threshold, the threshold allowing the determination between different sectors of the split cell and being based on the sector boundaries of one or more of the split cell sectors.

If the received signal strength is above the threshold, determining in which sector the mobile device is located may include selecting a sector which is geographically closer to the reference cell network element than other sectors in the split cell.

If the received signal strength is below the threshold, determining in which sector the mobile device is located may include selecting a sector which is geographically further from the reference cell network element than other sectors in the split cell.

In the case that the reference cell has handed over the mobile device to the split cell, the communications data may include a cell identity of the reference cell.

Determining in which sector the mobile device is located may include selecting the sector closest to a network element of the reference cell.

The method may comprise determining the reliability of the communications data.

Determining the reliability of the communications data may include estimating a distance between the mobile device and a network element of the split cell and, if the distance is below a threshold, establishing that the communications data is unreliable.

Estimating a distance between the mobile device and the network element of the split cell may include deriving the distance from timing values, for example one or more of a timing advance value and a round trip time, or any other measurement which may be used to estimate the distance between the mobile device and the network element.

The split cell may be used as the reference cell.

The communications data may include a timing value associated with communications between the mobile device and a network element of the split cell, the timing value being indicative of a distance between the mobile device and the split cell network element. The timing value may be a timing advance value or a round trip time, for example.

The split cell may include a first sector having a sector maximum range which is lower than that of other sectors in the split cell, the communications data further including the sector maximum range of the first sector.

Processing the communications data may include comparing the distance between the mobile device and the split cell network element, as indicated by the timing value, with the sector maximum range.

If the distance between the mobile device and the split cell network element is larger than the sector maximum range, determining in which sector the mobile device is located may include determining that the mobile device is not within the first sector.

The method may include repeating the comparing of the distance between the mobile device and the split cell network element with a sector maximum range of a second sector in the split cell.

According to a second aspect of the invention, there is provided an apparatus comprising
processing circuitry arranged to determine in which sector of a split cell in a cellular network a mobile device is located by processing communications data associated with communications between the mobile device and a reference cell in the cellular network;
the processing circuitry being further arranged to determine a sector boundary of the sector in which the mobile device is located by processing sector-related data associated with the split cell, the sector boundary providing an approximate determination of the geographical location of the mobile device.

The reference cell may be a neighboring cell adjacent the split cell.

The processing circuitry may be arranged to compare the received signal strength to a threshold, the threshold allowing the determination between different sectors of the split cell and being based on the sector boundaries of one or more of the split cell sectors.

The processing circuitry may be arranged to select a sector which is geographically closer to the reference cell network element than other sectors in the split cell if the received signal strength is above the threshold.

The processing circuitry may be arranged to select a sector which is geographically further from the reference cell network element than other sectors in the split cell if the received signal strength is below the threshold.

In the case that the reference cell has handed over the mobile device to the split cell, the communications data may include a cell identity of the neighboring cell.

The processing circuitry may be arranged to select the sector closest to a network element of the reference cell.

The processing circuitry may be arranged to determine the reliability of the communications data.

The processing circuitry may be arranged to estimate a distance between the mobile device and a network element of the split cell and, if the distance is below a threshold, establish that the communications data is unreliable.

The apparatus may be arranged to use the split cell as the reference cell.

The processing circuitry may be arranged to compare the distance between the mobile device and the split cell network element, as indicated by the timing value, with the sector maximum range.

The processing circuitry may be arranged to determine that the mobile device is not within the first sector if the distance between the mobile device and the split cell network element is larger than the sector maximum range.

The processing circuitry may be arranged to repeat the comparing of the distance between the mobile device and the split cell network element with a sector maximum range of a second sector in the split cell.

According to a third aspect of the invention, there is provided a mobile device including the apparatus of the second aspect.

According to a fourth aspect of the invention, there is provided a module for a mobile device including the apparatus of the second aspect.

According to a fifth aspect of the invention, there is provided a method comprising
the step of determining in which sector of a split cell in a cellular network a mobile device is located by processing communications data associated with communications between the mobile device and a reference cell in the cellular network;
the step of determining a sector boundary of the sector in which the mobile device is located by processing sector-related data associated with the split cell, the sector boundary providing an approximate determination of the geographical location of the mobile device.

According to an sixth aspect of the invention, there is provided an apparatus comprising
means for determining in which sector of a split cell in a cellular network a mobile device is located by processing communications data associated with communications between the mobile device and a reference cell in the cellular network;
means for determining a sector boundary of the sector in which the mobile device is located by processing sector-related data associated with the split cell, the sector boundary providing an approximate determination of the geographical location of the mobile device.

According to a seventh aspect of the invention, there is provided a software module comprising
code for determining in which sector of a split cell in a cellular network a mobile device is located by processing communications data associated with communications between the mobile device and a reference cell in the cellular network;
code for determining a sector boundary of the sector in which the mobile device is located by processing sector-related data associated with the split cell, the sector boundary providing an approximate determination of the geographical location of the mobile device.

According to a eighth aspect of the invention, there is provided a computer program directly loadable into the internal memory of a digital computer, comprising software code portions for performing the method of the first aspect when said program is run on the digital computer.

According to a ninth aspect of the invention, there is provided computer program product directly loadable into the internal memory of a digital computer, comprising software code portions for performing the method of the first aspect when said product is run on the digital computer.

According to a tenth aspect of the invention, there is provided carrier, which may comprise electronic signals, for a computer program of the eighth aspect.

According to an eleventh aspect of the invention, there is provided electronic distribution of a computer program of the eighth aspect.

Any circuitry may include one or more processors, memories and bus lines. One or more of the circuitries described may share circuitry elements.

The present invention includes one or more aspects, embodiments or features in isolation and in various combinations whether or not specifically stated (including claimed) in that combination or in isolation.

### BRIEF DESCRIPTION OF THE DRAWINGS

A description is now given, by way of example only, with reference to the accompanying drawings, in which:—

FIG. 1 is a schematic diagram of a split cell of a cellular network;

FIG. 2 is a schematic diagram of apparatus for providing assisted location determination for a mobile device in a cellular network;

FIG. 3 shows the determination of a sector boundary in the split cell of FIG. 1;

FIG. 4 is a schematic diagram of a split cell adjacent two neighboring cells, showing a mobile device and a threshold distance for determining the reliability of location determination;

FIG. 5 is a schematic diagram of alternative apparatus for providing assisted location determination for a mobile device in a cellular network.

### DETAILED DESCRIPTION

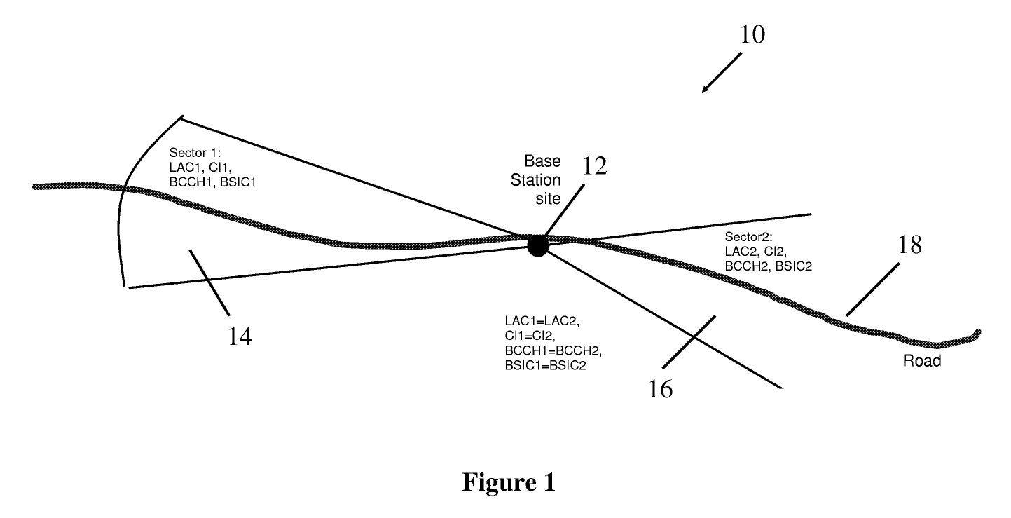

FIG. 1 is a schematic diagram of a split cell 10 of a cellular network.

The cell includes a base station 12 having an array antenna (not shown), whereby the cell is divided into two sectors: a first sector 14 and a second sector 16. The sectors 14, 16 are aligned with a road 18 in order to direct signals emanating from the array antenna towards parts of the surrounding region which are likely to include the highest numbers of network users. The base station 12 uses the same frequency, base station identity code (BSIC), cell identity (CI) and location area code (LAC) for each of the two sectors 14, 16.

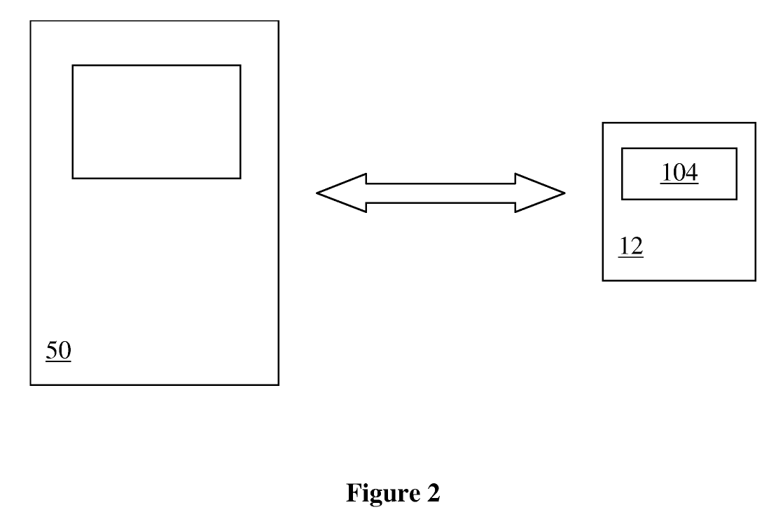

FIG. 2 is a schematic diagram of processing circuitry 104 for providing assisted location determination for a mobile device 50 in the cellular network.

The network is arranged to maintain a database storing data regarding the split cell 10, for example a sector bearing (in degrees), a sector width (in degrees) and a sector maximum range (or transmission power level) for each sector, in addition to coordinates of the base station 12. The data is used by the processing circuitry 104 to determine the locations of sector boundaries. In addition, the processing circuitry 104 is arranged to determine in which sector 14, 16 of the split cell 10 the mobile device 50 is located, using one or more operations as will be described below. Knowledge of the sector in which the mobile device 50 is located in combination with the determination of the sector boundary provides an approximate determination of the geographic location of the mobile device 50. Further location-determination operations may be performed to obtain a more precise estimate of the location of the mobile device 50.

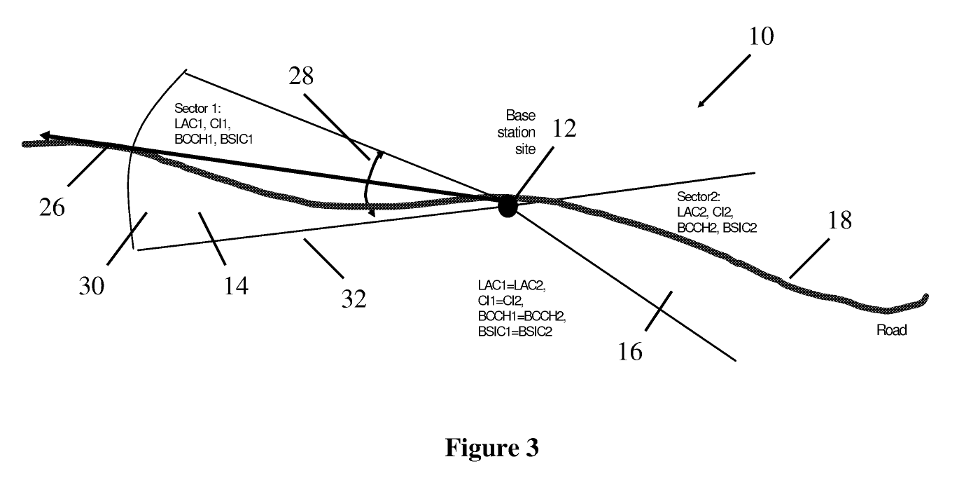

FIG. 3 shows the determination of a sector boundary 32 in the split cell 10 of FIG. 1 using the data stored by the network. Determination of which section 14, 16 of the split cell 10 the mobile device 50 is located in is discussed later.

In order to determine the sector boundary 32, the processing circuitry 104 uses the data relating to coordinates of base station 12, a sector bearing 26, a sector width 28 and a sector maximum range 30. In a variant, the processing circuitry 104 calculates the sector maximum range 30 from a transmission power level. In addition, sector width may be calculated from half-power beam width. The processing circuitry 104 determines the location of the boundary 32 such that it is in the form of a geometric sector with two radii each separated from the sector bearing 26 by half the sector width 28, the length of the radii each being equal to the sector maximum range 30, and the intersection of the two radii being positioned at the cell base station coordinates. In a variant, a safety margin may be added to the half-power beam width divided by two. Knowledge of the sector boundary 32 can be used in any of the operations described below. In a variant, the processing circuitry 104 determines the locations of a sector boundary only following a determination that the mobile device 50 is located in that sector.

For exemplary purposes only, the invention will be described with reference to the split cell 10 shown in FIG. 1. However, it will be appreciated that the invention is applicable to split cells having more sectors or different layouts or both.

The processing circuitry 104 operates to perform any one or more of two location-determination operations described below, to determine in which sector 14, 16 of the split cell the mobile device 50 is located.

In a first location-determination operation, the processing circuitry 104 uses a neighboring cell adjacent the split cell 10 as a reference cell.

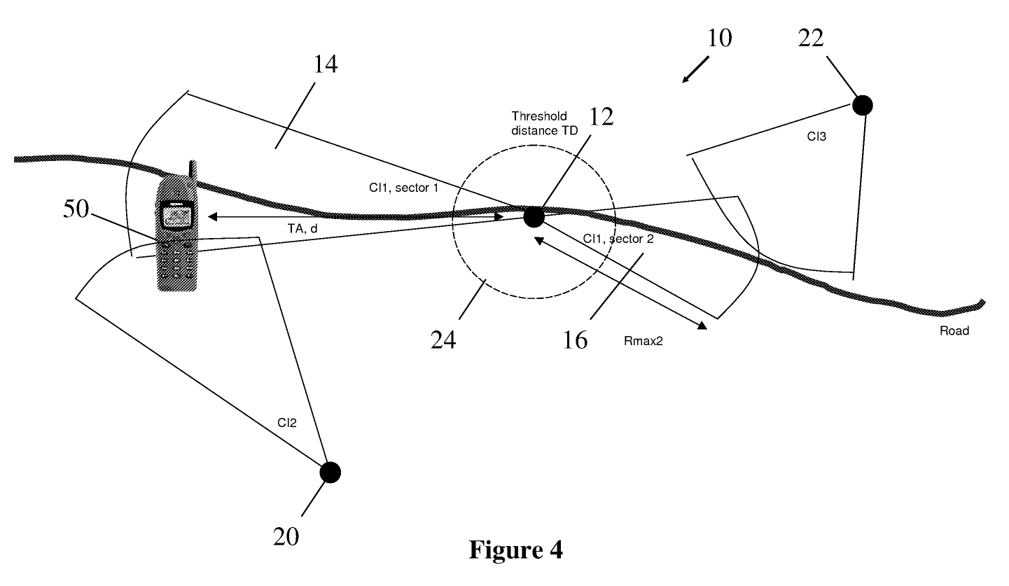

FIG. 4 shows first and second neighbouring cells 20, 22 available for use as the reference cell.

The processing circuitry 104 obtains a received signal strength associated with communications between the mobile device 50 and the first neighbouring cell 20. The mobile device 50 may measure the strength of a signal transmitted by the first neighboring cell 20 and received by the mobile device 50, and transmit the data to the processing circuitry 104. In a variant, the first neighboring cell 20 measures the strength of a signal transmitted by the mobile device 50 and transmits the data to the processing circuitry 104. The processing circuitry 104 compares the received signal strength to a first threshold associated with communications between the mobile device 50 and the first neighboring cell 20. The first threshold is set at a level such that signals having a received strength above the first threshold are more likely to have been received while the mobile device 50 was located in the first sector 14, which is closer to the first neighboring cell 20, while signals having a received strength below the first threshold are more likely to have been received while the mobile device 50 was located in the second cell 16, which is further from the first neighboring cell 20. The processing circuitry 104 is arranged to select the first sector 14 if the received signal strength is above the first threshold, and is arranged to select the second sector 16 if the received signal strength is below the first threshold, thereby to determine in which sector 14, 16 of the split cell 10 the mobile device 50 is located. The threshold may be calculated dynamically by the processing circuitry 104 or stored by the network. The threshold can be set using propagation models applicable to the environment or empirically defined (based on field measurements).

A situation may occur in which the base station of the first neighboring cell 20 is located on a line extending from the base station 12 of the split cell 10 and being perpendicular to a sector bearing 26 of the split cell 10. In this situation, the processing circuitry 104 is not able to distinguish between the sectors 14, 16 based on a received signal strength from the first neighboring cell 20. Accordingly, the processing circuitry 104 is arranged to detect a situation in which a determination between sectors cannot be made and to perform an alternative location-determination operation.

The processing circuitry 104 may perform the first location-determination operation using the second neighboring cell 22, as shown in FIG. 3, and a second threshold associated with that cell 22. This may be done in addition to or instead of the operation using the first neighboring cell 20. The second threshold is set in a similar manner to the first threshold. In this case, the processing circuitry 104 is arranged to select the first sector 14, which is further from the base station of the second neighboring cell 22 than the second sector 16, if the received signal strength is below the second threshold, and is arranged to select the second sector 16 if the received signal strength is above the second threshold, thereby to determine in which sector 14, 16 of the split cell 10 the mobile device 50 is located.

The processing circuitry 104 is arranged to perform the first location-determination operation using any one or more neighboring cells. Operations using one or more neighboring cells may be used to validate operations using one or more other neighboring cells.

In addition, the processing circuitry 104 is arranged to determine the reliability of the data by estimating a distance between the mobile device 50 and the base station 12 of the split cell 10 and comparing the distance with a reliability threshold. For example, a timing advance value or a round trip time is indicative of a distance between the mobile device 50 and the base station 12. If the distance is below the reliability threshold, the processing circuitry 104 establishes that the data is unreliable. FIG. 4 shows the reliability threshold represented by a circle 24 of a certain radius. If the mobile device 50 is located within the circle 24, the mobile device 50 is too close to the border between sectors 14, 16 for a reliable determination of location to be made.

An example of a timing advance value is that used by the GSM system. GSM uses a time-division multiple-access scheme (TDMA), which requires a degree of synchronization between a mobile device and the base station. The timing advance value records the degree of synchronization applied and measured by the base station on the uplink. The value of the timing advance is continuously calculated and transmitted to the mobile device during the connection. Since radio waves travel at a known rate, the timing advance value is indicative of the distance between the mobile device and the base station.

In a variant, the location-determination operations and sector-boundary-determination operations described herein are performed by the mobile device 50. In this case, the network is arranged to send the mobile device 50 an assistance data delivery message containing the data described herein during communications with the mobile device 50.

In a second location-determination operation, the processing circuitry 104 uses a neighboring cell 20, 22 adjacent the split cell 10 which has handed over the mobile device 50 to the split cell 10 as a reference cell. The data used by the processing circuitry 104 includes a cell identity and cell base station coordinates of the neighboring cell 20, 22. In this case, the processing circuitry 104 is arranged to determine in which sector 14, 16 the mobile device 50 is located by selecting the sector 14, 16 closest to the neighboring cell 20, 22. The locations of the boundaries of the sectors 14, 16 are determined as before. For example, with reference to FIG. 4, if the first neighboring cell 20 has handed over to the split cell 10, the processing circuitry 104 determines that the mobile device is located within the first sector 14. Alternatively, if the second neighboring cell 22 has handed over to the split cell 10, the processing circuitry 104 determines that the mobile device is located within the second sector 16.

The apparatus may be further arranged to use one or more of the above-described operations to validate other operations of the same or a different type.

In addition to the functionality described above, the processing circuitry 104 may be arranged to establish that the split cell 10 is sectorized before performing any of the above operations. In this respect, the processing circuitry 104 is arranged to determine the presence or otherwise of sector-related fields in the data stored by the network. The sector-related fields may include data on any one or more of (i) a sector maximum range; (ii) a sector width; (iii) a sector bearing.

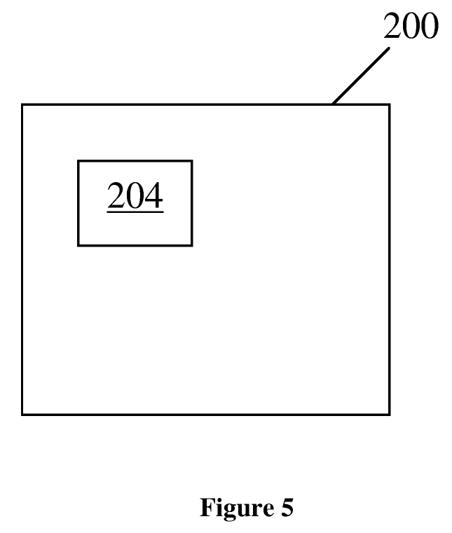

FIG. 5 shows an apparatus 200 including processing circuitry 204. Apparatus 200 forms part of a module for the mobile device 50 or a network element, for example part of the base station 12 or other part of the cellular network. Processing circuitry 204 has the same functionality as processing circuitry 104 described above. In a variant, the apparatus 200 includes its own antenna and transceiver circuitry.

In a validation operation for validating a result obtained using any location-determination operation described herein, the processing circuitry 104 uses the split cell 10 itself as a reference cell. The data used by the processing circuitry 104 includes a timing value indicative of a distance between the mobile device 50 and the base station 12, for example a timing advance value or a round trip time. The data further includes a sector maximum range of each sector 14, 16. As seen in FIG. 3, the sector maximum range of the second sector 16 is lower than that of the first sector 14. The processing circuitry 104 compares the distance between the mobile device 50 and the base station 12, as derived from the timing value, with the sector maximum range of the second sector 16. The processing circuitry 104 is arranged to determine that the mobile device 50 is not within the second sector 16 if the distance between the mobile device 50 and the base station 12 is larger than the sector maximum range of the second sector 16. In the sectorized cell 10 shown, which has only two sectors 14, 16, the processing circuitry is thus able to determine that the mobile device 50 is located in the first sector 14. The validation operation is only able to determine in which sector the mobile device is located when the cell includes two sectors, one sector has a larger maximum range than the other sector and the mobile device is positioned at a distance from the base station of the cell which is between the maximum ranges of the two sectors, such that the validation operation is used only to confirm that the results of other operations are correct.

Any coordinate data used by the invention may take the form of Universal Transverse Mercator (UTM), National Grid (in the UK), Irish Grid (in Ireland), or latitude and longitude, for example. However, it should be understood that the invention is not limited to any particular coordinate system. The processing circuitry may be arranged to convert between the different formats for more efficient use with local maps.

It will be appreciated that the aforementioned circuitry may have other functions in addition to the mentioned functions, and that these functions may be performed by the same circuitry.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the claimed invention.

While there have been shown and described and pointed out fundamental novel features of the claimed invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and method steps which perform substantially the same function in substantially the same way to achieve the same results are within the scope of the claimed invention. Moreover, it should be recognized that structures and elements and method steps shown and described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method comprising
determining in which sector of a split cell in a cellular network a mobile device is located by processing communications data associated with communications between the mobile device and a reference cell in the cellular network, and
determining a sector boundary of the sector in which the mobile device is located by processing sector-related data associated with the split cell, the sector boundary providing an approximate determination of a geographical location of the mobile device.

2. The method of claim 1 wherein the sector-related data includes a sector bearing, a sector width and a sector maximum range.

3. The method of claim 1 wherein the reference cell is a neighboring cell adjacent the split cell.

4. The method of claim 3 wherein the communications data includes a received signal strength associated with communications between the mobile device and a network element of the reference cell, and wherein processing the communications data includes comparing the received signal strength to a threshold, the threshold allowing a determination between different sectors of the split cell based on sector boundaries of one or more of the split cell sectors.

5. The method of claim 4 wherein, if the received signal strength is above the threshold, determining in which sector the mobile device is located includes selecting a sector which is geographically closer to the network element of the reference cell than other sectors in the split cell.

6. The method of claim 4 wherein, if the received signal strength is below the threshold, determining in which sector the mobile device is located includes selecting a sector which is geographically further from the network element of the reference cell than other sectors in the split cell.

7. The method of claim 3 wherein, in case the reference cell has handed over the mobile device to the split cell, the communications data includes a cell identity of the reference cell, and wherein determining in which sector the mobile device is located includes selecting a sector closest to a network element of the reference cell.

8. The method of claim 1 comprising determining reliability of the communications data.

9. The method of claim 8 wherein determining the reliability of the communications data includes estimating a distance between the mobile device and a network element of the split cell and, if the distance is below a threshold, establishing that the communications data is unreliable.

10. The method of claim 1 wherein the split cell is used as the reference cell.

11. The method of claim 10 wherein the communications data includes a timing value associated with communications between the mobile device and a network element of the split cell, the timing value being indicative of a distance between the mobile device and the split cell network element, wherein the split cell includes a first sector having a sector maximum range which is lower than that of other sectors in the split cell, the communications data further including the sector maximum range of the first sector, and wherein processing the communications data includes comparing the distance between the mobile device and the split cell network element, as indicated by the timing value, with the sector maximum range.

12. The method of claim 11 wherein, if the distance between the mobile device and the split cell network element is larger than the sector maximum range, determining in which sector the mobile device is located includes determining that the mobile device is not within the first sector.

13. The method of claim 12 including repeating the comparing of the distance between the mobile device and the split cell network element with a sector maximum range of another sector in the split cell.

14. An apparatus comprising
processing circuitry arranged to determine in which sector of a split cell in a cellular network a mobile device is located by processing communications data associated with communications between the mobile device and a reference cell in the cellular network;
the processing circuitry being further arranged to determine a sector boundary of the sector in which the mobile device is located by processing sector-related data associated with the split cell, the sector boundary providing an approximate determination of a geographical location of the mobile device.

15. The apparatus of claim 14 wherein the sector-related data includes a sector bearing, a sector width and a sector maximum range.

16. The apparatus of claim 14 wherein the reference cell is a neighboring cell adjacent the split cell.

17. The apparatus of claim 16 wherein the communications data includes a received signal strength associated with communications between the mobile device and a network element of the reference cell, and wherein the processing circuitry is arranged to compare the received signal strength to a threshold, the threshold allowing a determination between different sectors of the split cell based on sector boundaries of one or more of the split cell sectors.

18. The apparatus of claim 17 wherein the processing circuitry is arranged to select a sector which is geographically closer to the network element of the reference cell than other sectors in the split cell if the received signal strength is above the threshold.

19. The apparatus of claim 17 wherein the processing circuitry is arranged to select a sector which is geographically further from the network element of the reference cell than other sectors in the split cell if the received signal strength is below the threshold.

20. The apparatus of claim 14 wherein, in the case that the reference cell has handed over the mobile device to the split cell, the communications data includes a cell identity of the neighboring cell, and wherein the processing circuitry is arranged to select a sector closest to a network element of the reference cell.

21. The apparatus of claim 14 wherein the processing circuitry is arranged to determine reliability of the communications data.

22. The apparatus of claim 21 wherein the processing circuitry is arranged to estimate a distance between the mobile device and a network element of the split cell and, if the distance is below a threshold, establish that the communications data is unreliable.

23. The apparatus of claim 14 arranged to use the split cell as the reference cell.

24. The apparatus of claim 23 wherein the communications data includes a timing value associated with communications between the mobile device and a network element of the split cell, the timing value being indicative of a distance between the mobile device and the split cell network element, wherein the split cell includes a first sector having a sector maximum range which is lower than that of other sectors in the split cell, the communications data further including the sector maximum range of the first sector, and wherein the processing circuitry is arranged to compare the distance between the mobile device and the split cell network element, as indicated by the timing value, with the sector maximum range.

25. The apparatus of claim 24 wherein the processing circuitry is arranged to determine that the mobile device is not within the first sector if the distance between the mobile device and the split cell network element is larger than the sector maximum range.

26. The apparatus of claim 25 wherein the processing circuitry is arranged to repeat the comparing of the distance between the mobile device and the split cell network element with a sector maximum range of another sector in the split cell.

27. A mobile device including the apparatus of claim 14.

28. A module for a mobile device including the apparatus of claim 14.

29. A method comprising
determining in which sector of a split cell in a cellular network a mobile device is located by processing communications data associated with communications between the mobile device and a reference cell in the cellular network, and
determining a sector boundary of the sector in which the mobile device is located by processing sector-related data associated with the split cell, the sector boundary providing an approximate determination of a geographical location of the mobile device.

30. An apparatus comprising
means for determining in which sector of a split cell in a cellular network a mobile device is located by processing communications data associated with communications between the mobile device and a reference cell in the cellular network; and
means for determining a sector boundary of the sector in which the mobile device is located by processing sector-related data associated with the split cell, the sector boundary providing an approximate determination of a geographical location of the mobile device.

31. A software module comprising
code for determining in which sector of a split cell in a cellular network a mobile device is located by processing communications data associated with communications between the mobile device and a reference cell in the cellular network; and
code for determining a sector boundary of the sector in which the mobile device is located by processing sector-related data associated with the split cell, the sector boundary providing an approximate determination of a geographical location of the mobile device.

32. A computer program directly loadable into the internal memory of a digital computer, comprising software code portions for performing the method of claim 1 when said program is run on the digital computer.

33. A carrier, which may comprise electronic signals, for a computer program directly loadable into the internal memory of a digital computer, comprising software code portions for performing the method of claim 1 when said program is run on the digital computer.

34. Electronic distribution of a computer program directly loadable into the internal memory of a digital computer, comprising software code portions for performing the method of claim 1 when said program is run on the digital computer.
